(19) United States
(12) Patent Application Publication
(10) Pub. No.: US 2011/0212281 A1
(43) Pub. Date: Sep. 1, 2011

(54) DISK DRIVE HAVING A CONFORMAL LAMINATED COVER SEAL ADHERED A TOP FACE AND FOUR SIDE FACES OF A HELIUM-FILLED ENCLOSURE

(75) Inventors: Jon E. Jacoby, San Jose, CA (US); John R. Gustafson, Los Gatos, CA (US)

(73) Assignee: WESTERN DIGITAL TECHNOLOGIES, INC., Lake Forest, CA (US)

(21) Appl. No.: 12/714,297

(22) Filed: Feb. 26, 2010

(51) Int. Cl. B32B 1/02

(52) U.S. Cl. 428/35.8; 428/34.1

(57) ABSTRACT

A novel hermetically sealed disk drive comprises a disk drive enclosure that includes a disk drive base with a bottom face, four side faces, and a top cover, the enclosure having a top face. The hermetically sealed disk drive also comprises a laminated cover seal that includes a continuous metal foil, and a continuous adhesive layer coating the continuous metal foil. The laminated cover seal conforms to the disk drive enclosure and is adhered to the top face and to each of the four side faces by the continuous adhesive layer. The disk drive enclosure is helium-filled. The continuous metal foil of the laminated cover seal overlaps each of the four side faces by at least 5 mm.

### FIELD OF THE INVENTION

The present invention relates generally to information storage devices, and in particular to hermetically sealed disk drive information storage devices containing helium.

### BACKGROUND

The typical hard disk drive includes a head disk assembly (HDA) and a printed circuit board assembly (PCBA) attached to a disk drive base of the HDA. The HDA includes at least one disk (such as a magnetic disk, magneto-optical disk, or optical disk), a spindle motor for rotating the disk, and a head stack assembly (HSA). The PCBA includes electronics and firmware for controlling the rotation of the spindle motor and for controlling the position of the HSA, and for providing a data transfer channel between the disk drive and its host.

The spindle motor typically includes a rotor including one or more rotor magnets and a rotating hub on which disks are mounted and clamped, and a stator. If more than one disk is mounted on the hub, the disks are typically separated by spacer rings that are mounted on the hub between the disks. Various coils of the stator are selectively energized to form an electromagnetic field that pulls/pushes on the rotor magnet(s), thereby rotating the hub. Rotation of the spindle motor hub results in rotation of the mounted disks.

The HSA typically includes an actuator, at least one head gimbal assembly (HGA), and a flex cable assembly. During operation of the disk drive, the actuator must rotate to position the HGAs adjacent desired information tracks on the disk. The actuator includes a pivot-bearing cartridge to facilitate such rotational positioning. The pivot-bearing cartridge fits into a bore in the body of the actuator. One or more actuator arms extend from the actuator body. An actuator coil is supported by the actuator body, and is disposed opposite the actuator arms. The actuator coil is configured to interact with one or more fixed magnets in the HDA, to form a voice coil motor. The PCBA provides and controls an electrical current that passes through the actuator coil and results in a torque being applied to the actuator.

Each HGA includes a head for reading and writing data from and to the disk. In magnetic recording applications, the head typically includes a slider and a magnetic transducer that comprises a writer and a read element. In optical recording applications, the head may include a minor and an objective lens for focusing laser light on to an adjacent disk surface. The slider is separated from the disk by a gas lubrication film that is typically referred to as an “air bearing.” The term “air bearing” is common because typically the lubricant gas is simply air. However, air bearing sliders have been designed for use in disk drive enclosures that contain helium, because an inert gas may not degrade lubricants and protective carbon films as quickly as does oxygen. Helium may also be used, for example, because it has higher thermal conductivity than air, and therefore may improve disk drive cooling. Also, because the air bearing thickness depends on the gas viscosity and density, the air bearing thickness may be advantageously reduced in helium relative to air (all other conditions being the same). Furthermore, because helium has lower density than air, its flow (e.g. flow that is induced by disk rotation) may not buffet components within the disk drive as much, which may reduce track misregistration and thereby improve track following capability—facilitating higher data storage densities.

Disk drive enclosures disclosed in the art to contain helium are typically hermetically sealed to prevent an unacceptable rate of helium leakage. Although some negligible amount of helium leakage is unavoidable, a non-negligible amount of helium leakage is undesirable because it can alter the thickness of the gas lubrication film between the head and the disk, and thereby affect the performance of the head. A non-negligible amount of helium leakage is also undesirable because it can alter the tribochemistry of the head disk interface, possibly leading to degradation in reliability, head crashes, and associated data loss.

Various methods and structures that have been disclosed in the past to hermetically seal disk drive enclosures have been too costly, have required too much change to existing disk drive manufacturing processes, and/or were not able to retain helium internal to the disk drive enclosure for sufficient time to ensure adequate product reliability. Thus, there is a need in the art for disk drive enclosure sealing methods and structures that may be practically implemented and integrated in a high volume and low cost disk drive manufacturing process, and that can retain helium internal to a disk drive enclosure for a sufficient period of time to ensure adequate post-manufacture product reliability and lifetime.

### SUMMARY

A novel hermetically sealed disk drive comprises a disk drive enclosure that includes a disk drive base with a bottom face, four side faces, and a top cover. The disk drive enclosure has a top face that includes an upper surface of the top cover and an upper surface of the disk drive base. The hermetically sealed disk drive also comprises a laminated cover seal that includes a continuous metal foil, and a continuous adhesive layer coating the continuous metal foil. The laminated cover seal conforms to the disk drive enclosure, substantially covers the top face, and is adhered to the top face and to each of the four side faces by the continuous adhesive layer. The disk drive enclosure is helium-filled. The continuous metal foil of the laminated cover seal overlaps each of the four side faces by at least 5 mm.

### BRIEF DESCRIPTION OF THE DRAWINGS

FIG. 1A is an exploded perspective view of a disk drive including a laminated cover seal according to an embodiment of the present invention.

FIG. 1B is a cross sectional view of the laminated cover seal of FIG. 1A, taken at the location 1B-1B depicted in FIG. 1A.

FIG. 2 is a perspective view of the disk drive of FIG. 1A, with the laminated cover seal in place.

FIG. 3 is an exploded perspective view of a disk drive including a laminated cover seal according to another embodiment of the present invention.

FIG. 4 is a perspective view of the disk drive of FIG. 3, with the laminated cover seal in place.

### DESCRIPTION OF THE PREFERRED EMBODIMENTS

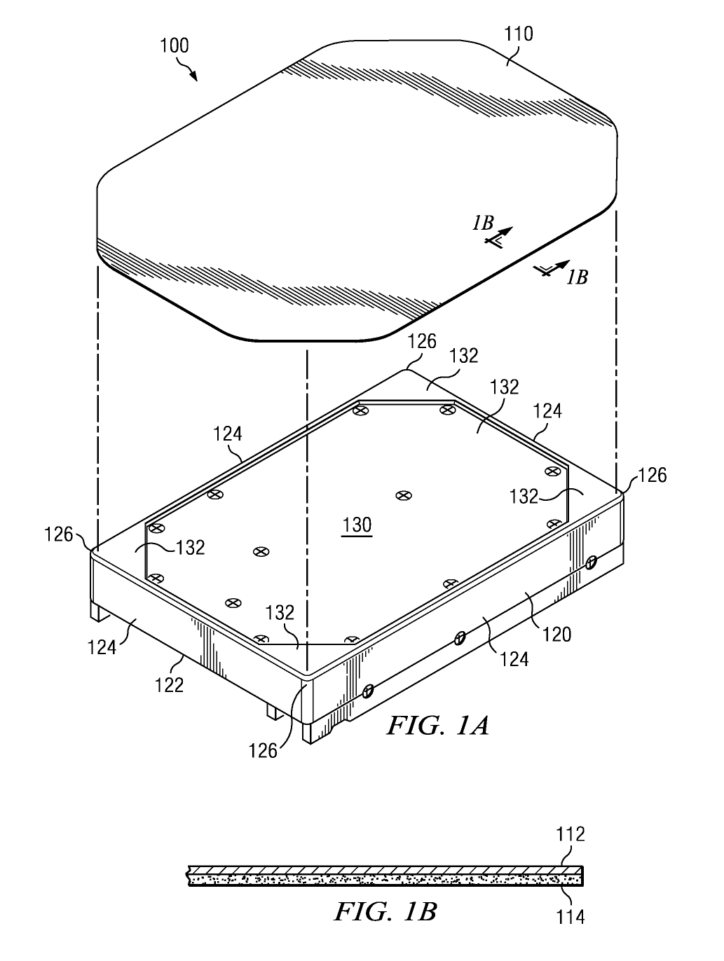

FIG. 1A is an exploded perspective view of a hermetically sealed disk drive 100 according to an embodiment of the present invention. The disk drive 100 includes a disk drive enclosure that includes a laminated cover seal 110, a disk drive base 120, and a top cover 130. The disk drive base 120 includes a bottom face 122 and four side faces 124. The enclosure of disk drive 100 has a top face 132 that includes an upper surface of the top cover 130 and that includes the upper surface of the disk drive base 120 near its four corners 126.

The enclosure of disk drive 100 is helium-filled (i.e. encloses a substantial concentration of helium gas). Practically, the concentration of enclosed helium gas (e.g. versus remaining air) will be less than 100% initially, and is expected to drop over the useful life of the disk drive 100. Still, the disk drive 100 may be considered “helium-filled” throughout its useful life so long as it continues to enclose a substantial concentration of helium gas. Note also that 1.0 atmosphere pressure of helium is not required for the disk drive 100 to be considered “helium-filled.” For example, the helium-filled disk drive enclosure preferably initially encloses helium having between 0.3 to 1.0 atmosphere partial pressure, and may also enclose air having between 0 to 0.7 atmosphere partial pressure. In certain applications, it may be desirable for at least 70% of the helium gas that is initially enclosed to remain enclosed after a 10 year useful life of the hermetically sealed disk drive.

FIG. 1B is a cross sectional view of the laminated cover seal 110 of FIG. 1A, taken at the location depicted as 1B-1B in FIG. 1A. Now referring additionally to FIG. 1B, the laminated cover seal 110 includes a continuous metal foil 112, and a continuous adhesive layer 114 coating the continuous metal foil 112. In the present context, a “continuous metal foil” is a metal foil that continuously covers each opening in the top face of the disk drive enclosure through which helium might escape (e.g. the seam around the top cover 130, screw holes in the top cover to support an actuator pivot and/or spindle shaft, etc). It is not necessary for a metal foil to have zero openings or holes to qualify as a “continuous metal foil” herein, because so long as any such openings or holes in the continuous metal foil are disposed at least 5 mm away from each opening in the top face of the disk drive enclosure, the metal foil will still continuously cover each opening in the top face of the disk drive enclosure.

By contrast, in the present context a “continuous adhesive layer” is an adhesive layer that continuously encircles an opening in the top face of the disk drive enclosure through which helium might escape (e.g. the seam around the top cover 130, screw holes in the top cover to support an actuator pivot and/or spindle shaft, etc). It is not necessary for an adhesive layer to continuously adhere to the top cover 130 (or even to adhere to the top cover 130 at all) to qualify as a “continuous adhesive layer” herein, so long as the adhesive layer encircles an openings in the top face of the disk drive enclosure. For example, the continuous adhesive layer 114 may continuously encircle the periphery of top cover 130 by optionally adhering only to the sides of the disk drive base 120 and to the upper surface of the disk drive base 120 near the corners 126 (and therefore to the upper face of the enclosure of disk drive 100), without adhering to the top cover 130 itself.

Optionally but not necessarily, the laminated cover seal 110 may include two overlapping layers of continuous metal foil 112 (rather than just one as shown in FIG. 1B), so that any small pores or imperfections that exist in one of the continuous metal foil layers will be unlikely to be aligned with any small pores or imperfections in the other (overlapping) one of the continuous metal foil layers. Also optionally but not necessarily, the continuous metal foil 112 may comprise a polymer backing layer and a metal film deposited on the polymer backing layer, with the metal film having a metal film thickness in the range 0.1 to 5 microns.

In the embodiment of FIG. 1B, the continuous metal foil 112 may be a pure metal or metal alloy foil that includes copper, aluminum, stainless steel, tin, lead, and/or gold, for example. The continuous metal foil 112 preferably defines a metal foil thickness in the range 12 to 150 microns, so that small pores and/or imperfections in the continuous metal foil 112 will be unlikely to frequently pass all the way through the layer. Also in the embodiment of FIG. 1B, the continuous adhesive layer 114 may include a thermal set epoxy adhesive or an acrylic pressure sensitive adhesive, for example. The continuous adhesive layer 114 preferably defines an adhesive layer thickness in the range 25 to 50 microns.

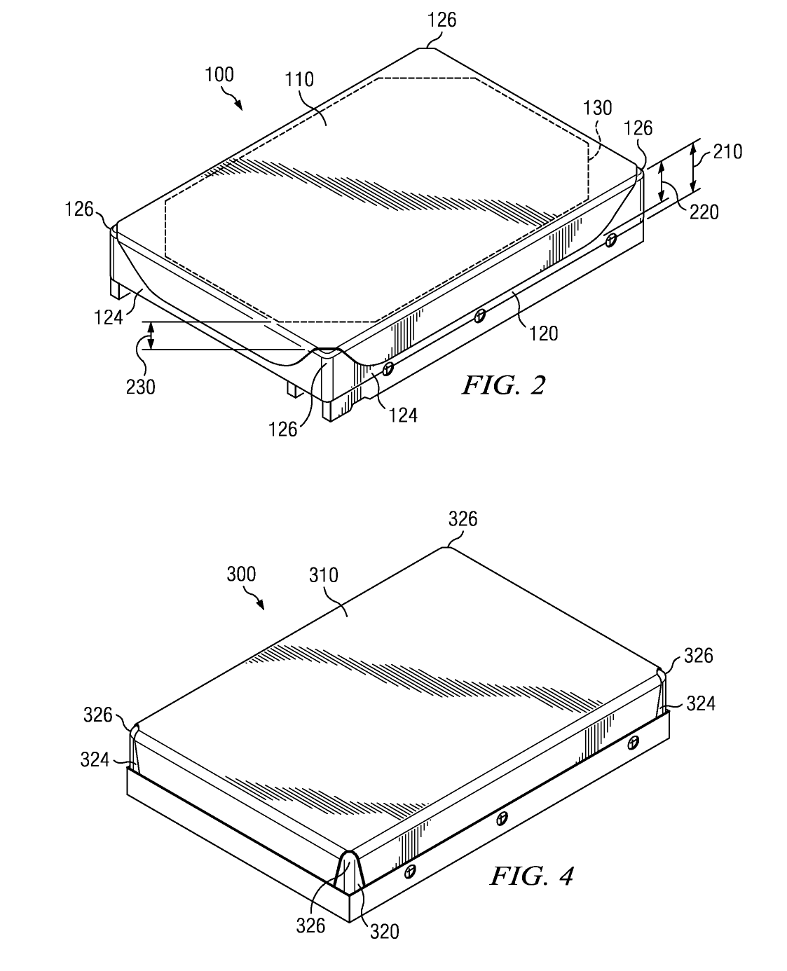

FIG. 2 is a perspective view of the disk drive of FIG. 1A, with the laminated cover seal 110 in place. Now referring additionally to FIG. 2, the laminated cover seal 110 conforms to the disk drive enclosure, substantially covers the top face 132, and is adhered to the top face 132 and to each of the four side faces 124 by the continuous adhesive layer 114. Although the laminated cover seal 110 almost completely covers the top face 132 of the disk drive enclosure in the preferred embodiment of FIG. 2, in an alternative embodiment the laminated cover seal 110 may include openings disposed at least 5 mm away from each opening in the top face 132, such that substantial portions of the top face 132 are not covered. For example, the laminated cover seal 110 need not cover regions of the top cover 130 that are at least 5 mm away from its periphery and from any screw therethrough.

In the embodiment of FIG. 2, each of the four side faces 124 defines a side face height 210. The continuous metal foil 112 of the laminated cover seal 110 overlaps each of the four side faces 124 by an overlap distance 220, which may be expressed as a percentage of the side face height 210. For example, for a so-called 3.5 inch form factor disk drive the overlap distance 220 is preferably at least 20% of the side face height 210. Also for example, for a so-called 2.5 inch form factor disk drive the overlap distance 220 is preferably at least 33% of the side face height 210.

In the embodiment of FIG. 2, if thermal set epoxy adhesive is used in the continuous adhesive layer 114, then the overlap distance 220 is preferably at least 5 mm to sufficiently reduce the rate of helium diffusion through the continuous adhesive layer 114. If acrylic pressure sensitive adhesive is used in the continuous adhesive layer 114, then the continuous metal foil 112 of the laminated cover seal 110 preferably overlaps each of the four side faces 124 by at least 12 mm to sufficiently reduce the rate of helium diffusion through the continuous adhesive layer 114. The aforementioned layer thickness ranges for the layers of the laminated cover seal 110, and the overlap minimums described above, may serve to retain helium internal to a disk drive enclosure for a sufficient period of time to ensure adequate post-manufacture product reliability and lifetime.

Note that in the embodiment of FIG. 1A, the top cover 130 is generally hexagonal in shape so that it does not overlie the corners 126 of the disk drive 100. The laminated cover seal 110 is adhered to the upper surface of the disk drive base 120 adjacent the corners 126. As shown in FIG. 2, the laminated cover seal 110 also extends closer to the corners 126 than does the top cover 130, so that the laminated cover seal 110 continuously overlaps the disk drive base 120 at the corners by a corner overlap distance 230. If thermal set epoxy adhesive is used in the continuous adhesive layer 114, then the corner overlap distance 230 is preferably at least 5 mm to sufficiently reduce the rate of helium diffusion through the continuous adhesive layer 114. The hexagonal shape and minimum corner overlap distance described above may serve to help retain helium internal to a disk drive enclosure for a sufficient period of time to ensure adequate post-manufacture product reliability and lifetime.

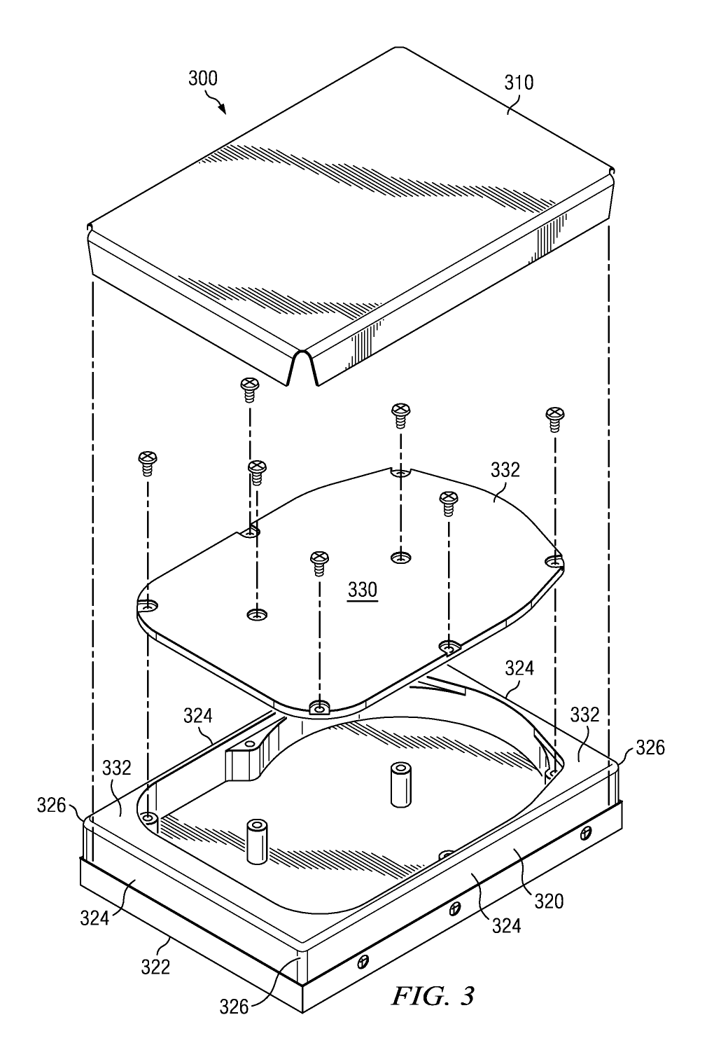

FIG. 3 is an exploded perspective view of a hermetically sealed disk drive 300 according to another embodiment of the present invention. The hermetically sealed disk drive 300 includes a disk drive enclosure that includes a laminated cover seal 310, a disk drive base 320, and a top cover 330. The disk drive base 320 includes a bottom face 322 and four side faces 324. The enclosure of disk drive 300 has a top face 332 that includes an upper surface of the top cover 330 and that includes the upper surface of the disk drive base 320 near its four corners 326. The disk drive enclosure is helium-filled (i.e. encloses a substantial concentration of helium gas). For example, the helium-filled disk drive enclosure preferably encloses helium having between 0.3 to 1.0 atmosphere partial pressure, and may also enclose air having between 0 to 0.7 atmosphere partial pressure.

The laminated cover seal 310 may include a continuous metal foil and a continuous adhesive layer coating the continuous metal foil as described previously with respect to FIG. 1B. Optionally but not necessarily, the laminated cover seal 310 may include two overlapping layers of continuous metal foil. Also optionally but not necessarily, the continuous metal foil of the laminated cover seal 310 may comprise a polymer backing layer and a metal film deposited on the polymer backing layer, with the metal film having a metal film thickness in the range 0.1 to 5 microns.

FIG. 4 is a perspective view of the disk drive of FIG. 3, with the laminated cover seal 310 and disk drive top cover 330 in place. Now referring additionally to FIG. 4, the laminated cover seal 310 conforms to the disk drive enclosure, substantially covers the top face 332, and is adhered to the top face 332 and to each of the four side faces 324 by a continuous adhesive layer. The continuous metal foil of the laminated cover seal 310 overlaps each of the four side faces by at least 5 mm to sufficiently reduce the rate of helium diffusion through the continuous adhesive layer. If acrylic pressure sensitive adhesive is used in the continuous adhesive layer of the laminated cover seal 310, then the continuous metal foil of the laminated cover seal 310 preferably overlaps each of the four side faces 324 by at least 12 mm to sufficiently reduce the rate of helium diffusion through the continuous adhesive layer. These overlap minimums may serve to retain helium internal to a disk drive enclosure for a sufficient period of time to ensure adequate post-manufacture product reliability and lifetime.

Note that in the embodiment of FIG. 4, the top cover 330 does not overlie the corners 326 of the disk drive 300. The laminated cover seal 310 is adhered to sides and the upper surface of the disk drive base 320 adjacent the corners 326, so the adhesive layer of the laminated cover seal 310 completely encircles all openings in the upper face of the disk drive enclosure. As such, the laminated cover seal 310 may be considered to include a continuous adhesive layer even if the laminated cover seal 310 is not adhered to the top cover 330 (and even if the laminated cover seal 310 were to lack an adhesive layer over the top cover 330). As shown in FIG. 4, the laminated cover seal 310 also extends closer to the corners 326 than does the top cover 330, so that the laminated cover seal 310 can continuously overlap the disk drive base 320 to completely encircle all openings in the upper face of the disk drive enclosure.

In the foregoing specification, the invention is described with reference to specific exemplary embodiments, but those skilled in the art will recognize that the invention is not limited to those. It is contemplated that various features and aspects of the invention may be used individually or jointly and possibly in a different environment or application. The specification and drawings are, accordingly, to be regarded as illustrative and exemplary rather than restrictive. “Comprising,” “including,” and “having,” are intended to be open-ended terms.

We claim:

1. A hermetically sealed disk drive comprising:
a disk drive enclosure including
a disk drive base with a bottom face and four side faces, and
a top cover, wherein the disk drive enclosure has a top face that includes an upper surface of the top cover and an upper surface of the disk drive base; and
a laminated cover seal including
a continuous metal foil, and
a continuous adhesive layer coating the continuous metal foil;
wherein the laminated cover seal conforms to the disk drive enclosure and is adhered to the top face and to each of the four side faces by the continuous adhesive layer;
wherein the continuous metal foil of the laminated cover seal overlaps each of the four side faces by at least 5 mm; and
wherein the disk drive enclosure is helium-filled.

2. The hermetically sealed disk drive of claim 1 wherein the laminated cover seal substantially covers the top face.

3. The hermetically sealed disk drive of claim 1 wherein the continuous adhesive layer comprises thermal set epoxy.

4. The hermetically sealed disk drive of claim 1 wherein the continuous adhesive layer comprises acrylic pressure sensitive adhesive, and wherein the continuous metal foil of the laminated cover seal overlaps each of the four side faces by at least 12 mm.

5. The hermetically sealed disk drive of claim 1 wherein the continuous metal foil comprises copper foil.

6. The hermetically sealed disk drive of claim 1 wherein the continuous metal foil comprises aluminum foil.

7. The hermetically sealed disk drive of claim 1 wherein the continuous metal foil comprises stainless steel foil.

8. The hermetically sealed disk drive of claim 1 wherein the continuous adhesive layer defines an adhesive layer thickness in the range 25 to 50 microns.

9. The hermetically sealed disk drive of claim 1 wherein the continuous metal foil defines a metal foil thickness in the range 12 to 150 microns.

10. The hermetically sealed disk drive of claim 1 wherein the a laminated cover seal includes two overlapping layers of continuous metal foil.

11. The hermetically sealed disk drive of claim 1 wherein two of the four side faces meet at a corner, and wherein the top cover is generally hexagonal in shape so that it does not overlie the corner, and wherein the laminated cover seal extends at least 5 mm closer to the corner than does the top cover, and wherein the laminated top cover is adhered to the disk drive base adjacent the corner.

12. The hermetically sealed disk drive of claim 1 wherein the helium-filled enclosure encloses helium having between 0.3 to 1.0 atmosphere partial pressure.

13. The hermetically sealed disk drive of claim 12 wherein the helium-filled enclosure also encloses air having between 0 to 0.7 atmosphere partial pressure.

14. The hermetically sealed disk drive of claim 1 wherein the continuous metal foil includes a polymer layer and a deposited metal film, and wherein the deposited metal film defines a film thickness in the range 0.1 to 5 microns.

15. The hermetically sealed disk drive of claim 1 wherein each of the four side faces defines a side face height, and wherein the continuous metal foil of the laminated cover seal overlaps each of the four side faces by at least 20% of the side face height.
